(19) United States
(12) Patent Application Publication
(10) Pub. No.: US 2013/0112621 A1
(43) Pub. Date: May 9, 2013

(54) Water filtration article and related methods

(71) Applicants: Lei Zheng, Newark, DE (US); Guy Sbriglia, Christiana, PA (US)

(72) Inventors: Lei Zheng, Newark, DE (US); Guy Sbriglia, Christiana, PA (US)

(21) Appl. No.: 13/288,540

(22) Filed: Nov. 3, 2011

(51) Int. Cl. C02F 1/44; B01D 67/00; B01D 63/00

(52) U.S. Cl. 210/650; 210/490; 427/244

(57) ABSTRACT

A water filtration article has a filtration layer of thickness no larger than 10 microns including porous polytetrafluoroethylene coated with a hydrophilic coating comprising uncrosslinked ethylene-vinyl alcohol copolymer. Methods include water filtration using and manufacture of such a water filtration article.

### FIELD OF THE INVENTION

The invention relates to a water filtration article having a filtration membrane with porous polytetrafluoroethylene coated with a hydrophilic coating comprising uncrosslinked copolymer of ethylene and vinyl alcohol, and to methods of water filtration and manufacture of water filtration articles.

### BACKGROUND OF THE INVENTION

Porous polytetrafluoroethylene (PTFE) has been used as a filter media for very fine particle separations from aqueous liquid media, for example for preparing ultrapure water for use in the semiconductor and pharmaceutical industries. The porous PTFE may be in an expanded form, often referred to as expanded polytetrafluoroethylene (ePTFE), that has a microstructure with PTFE fibrils and provides a highly porous network that may be made with a very small average pore size for very fine particle filtration.

PTFE is a highly hydrophobic material and will not significantly wet-out water without some type of pre-treatment. One approach for addressing the hydrophobicity of PTFE filtration media is to pre-wet the PTFE with a surfactant or a solvent compatible with wetting-out water. For example, the PTFE may be pre-wetted with an alcohol that is miscible with water, for example isopropyl alcohol, prior to contacting the PTFE filtration membrane with a water stream to be filtered. One problem with this approach is that the pre-wetted PTFE is susceptible to drying out before or between uses and may need to be repeatedly subjected to such pre-wetting.

Another approach for addressing hydrophobicity of PTFE filtration media is to coat the porous PTFE structure with a hydrophilic coating, such as with a hydrophilic polymer. Stability of such a coating is of critical importance for ultrapure water filtration applications, because coating material may be extracted or dislodged during filter operation and contaminate the fluid being processed. During such water filtration applications the PTFE filtration media is subjected to a significant pressure drop, and the flow of fluid through the PTFE filtration media pore space creates significant shear within the PTFE pore space that may affect the stability of a polymer coating. Industry continues to desire ultrapure water filters with higher performance filter media operable for finer particle separations and at higher filter flux rates, for which hydrophilic coating stability becomes even more critical.

The difficulty of obtaining good PTFE water filter performance becomes even more difficult as the thickness of filtration layers becomes smaller. U.S. Patent Publication 2011/0052900 discloses that for PTFE porous bodies having a thickness of 20 microns or less, when hydrophilic polymer coating dries and shrinks the PTFE porous body may also shrink, decreasing filter performance. US 2011/0052900 discloses hydrophilic treatment of PTFE in a porous filter by “insolubilizing” a hydrophobic material by cross-linking. The document discloses polyvinyl alcohol, ethylene-vinyl alcohol copolymers and acrylate resins for use as the hydrophilic material, with all illustrated examples using polyvinyl alcohol. Cross-linking hydrophilic polymer as disclosed in US2011/0052900 may help to immobilize the polymer on the porous PTFE filtration media, but such a cross-linking operation introduces undesirable added complexity and cost to manufacture processing.

### SUMMARY OF THE INVENTION

In a first aspect, the present invention provides a water filtration article having a filtration membrane with a porous polytetrafluoroethylene (PTFE) structure comprising uncrosslinked ethylene-vinyl alcohol (EVOH) copolymer and a hydrophilic coating over at least a portion of the porous PTFE structure. Such a water filtration article is particularly well-suited for ultrapure water applications, such as those in the semiconductor and pharmaceutical industries. The filtration membrane has at least one filtration layer that has a thickness of no larger than about 10 microns. The filtration layer includes porous PTFE filtration media and the hydrophilic coating comprises uncrosslinked ethylene-vinyl alcohol copolymer on the PTFE filtration media. By filtration layer, it is meant a layer that is determinative of the particle-size separation performance of the filtration membrane, as opposed to other layers of the filtration membrane that may provide structural support to such a filtration layer or may provide some other ancillary function. In that regard, most of the pressure drop across such a filtration membrane when in operation will be across the filtration layer or layers.

It has been found that uncrosslinked EVOH copolymer may be remarkably stable on porous PTFE structures of filtration membranes even when the porous PTFE structure is subjected to significant differential pressure and fluid flow conditions encountered during ultrapure water filtration operations, and without the added cost and complexity of having to perform a cross-linking operation. Also, it has been identified that a cross-linking operation may leave substantial amounts of residual extractable organics on the porous PTFE structure that may provide a source of contamination during filter operations. Such residual extractable material may be referred as “extractables”. Such residual extractable material is particularly troublesome in the ultrapure water filtration context, because of susceptibility of such material to being released as a contaminant during a filtration operation. With the present invention, the cost and complexity of cross-linking may be avoided, as well as the presence of such residual extractable material.

A number of refinements and additional features may be implemented with the water filtration article of the first aspect, which refinements and additional features may be used individually or in any combination. Accordingly, the various refinements and additional features that follow may be or may not be used in any particular implementation of the water filtration article of the first aspect.

The filtration layer may have one or more features contributing to high performance filtration operation to remove very fine particles. The filtration layer may have an average pore size that is no larger than 0.2 micron, no larger than 0.1 micron or even no larger than 0.05 micron. In this regard, the filtration layer may provide for filtration of very small particles. For many applications the filtration layer will have an average pore size of at least 0.005 micron. The filtration layer may have an even smaller thickness than 10 microns. The filtration layer may have a thickness of no larger than 7 microns, no larger than 5 microns, no larger than 4 microns, no larger than 3 microns or no larger than 2 microns. The filtration layer may have a thickness for many applications of at least 0.5 micron or at least 1 micron. The filtration membrane may have a bubble point for some applications of at least 200 kPa or at least 500 kPa. The filtration membrane may often have a bubble point of no larger than 1400 kPa. The bubble point provides an indication of pore size and is primarily a function of the filtration layer or layers within the membrane that are determinative of the fineness of particle separation that may be effected using the filtration membrane. Even though the filtration membrane may be suitable for very fine particle filtration, the filtration membrane may exhibit a significant water flux. The filtration membrane may have a pressure-normalized water flux of at least 0.01 ml/min/cm²/kPa, at least 0.1 ml/min/cm²/kPa or at least 0.5 ml/min/cm²/kPa. For many applications, the filtration membrane will have a pressure-normalized water flux of not more than 100 ml/min/cm²/kPa.

The coating may include one or more components in addition to the uncrosslinked EVOH copolymer, but in some preferred implementations the coating consists of or consists essentially of uncrosslinked EVOH copolymer. The filtration membrane, or the filtration layer of the filtration membrane, may comprise one or more components in addition to PTFE and uncrosslinked EVOH copolymer, but in some preferred implementations the filtration membrane consists of or consists essentially of PTFE and uncrosslinked EVOH copolymer. PTFE may typically be a predominant component and the uncrosslinked EVOH copolymer a minor component. The filtration membrane, or the filtration layer portion of the filtration membrane, may comprise PTFE in a range having a lower limit of 70 weight percent, 80 weight percent, 90 weight percent, 95 weight percent or 97 weight percent and an upper limit of 99.9 weight percent, 99.5 weight percent, 99 weight percent or 98 weight percent. The filtration membrane, or the filtration layer portion of the filtration membrane, may comprise uncrosslinked EVOH copolymer in a range having a lower limit of 0.1 weight percent, 0.5 weight percent, 1 weight percent or 2 weight percent and having an upper limit of 30 weight percent, 20 weight percent, 10 weight percent, 5 weight percent or 3 weight percent. The filtration membrane, or the filtration layer portion of the filtration membrane, may comprise one or more components other than PTFE and uncrosslinked EVOH copolymer. The filtration membrane, or the filtration layer portion of the filtration membrane, may be comprised mostly or substantially entirely of PTFE and uncrosslinked EVOH copolymer. PTFE and uncrosslinked EVOH copolymer together may comprise at least 90 weight percent, at least 95 weight percent, at least 98 weight percent or at least 99 weight percent of the filtration membrane, or may comprise 100 weight percent of the filtration membrane.

The PTFE of the filtration membrane, or of the filtration layer portion of the filtration membrane, may be ePTFE. The porous PTFE structure of the filtration membrane may be prepared, for example, according to methods described in U.S. Pat. Nos. 7,306,729; 3,953,566; 5,476,589; or 5,183,545.

The uncrosslinked EVOH copolymer is a polymer with a polyvinyl backbone and ethylene (ethene) and vinyl alcohol (ethenol) repeating units. By uncrosslinked it is meant that individual copolymer molecules have not been linked through cross-linking reactions. The uncrosslinked EVOH copolymer may be a random or block copolymer, preferably a random copolymer. The uncrosslinked EVOH copolymer may include a minor quantity of repeating units in addition to ethylene and vinyl alcohol, but preferably repeating units of the uncrosslinked EVOH copolymer consist of or consist essentially of polyethylene and vinyl alcohol repeating units. The uncrosslinked EVOH copolymer may be a molecular weight in a range of from 10,000 to 500,000 Daltons. In addition to being uncrosslinked, the uncrosslinked EVOH copolymer may advantageously also be unreacted before, during or following disposition on the porous PTFE structure. For example, the uncrosslinked EVOH copolymer is preferably not reacted to further functionalize (e.g., through grafting) or stabilize the uncrosslinked EVOH copolymer.

The filtration membrane may consist essentially of only a single layer, a filtration layer. Alternatively, the filtration membrane may be a multi-layer structure including at least one filtration layer and may include multiple filtration layers and/or one or more other layers, for example support layers. The filtration membrane may comprise a porous support layer adjacent a side of the filtration layer. The support layer may comprise a portion of the porous PTFE structure that has the hydrophilic coating. The filtration membrane may comprise multiple porous support layers, for example a second porous support layer adjacent a second side of the filtration layer opposite a first porous support layer. Any such porous support layer may have a thickness larger than the thickness of the adjacent filtration layer and may have an average pore size larger than an average pore size of the adjacent filtration layer. Any such porous support layer may also comprise a portion of the PTFE structure with the hydrophilic coating disposed thereon. In some implementations, the filtration membrane comprises a filtration layer, a first porous support layer adjacent one side of the filtration layer and a second porous support layer adjacent a second side of the filtration layer opposite the first side, and wherein each of the filtration layer, the first porous support layer and the second porous support layer consists of or consists essentially of PTFE and uncrosslinked EVOH copolymer.

The water filtration article may consist of only the filtration membrane, or the water filtration article may be a more complex structure of which the filtration membrane is a part. The water filtration article may include a porous polymeric backing structure laminated to the filtration membrane, for example to provide additional support and protection to the filtration membrane. The water filtration article may include multiple porous polymeric backing structures, for example with a porous polymeric backing structure laminated to opposing sides of the filtration membrane, and the porous polymeric backing structures may be made of the same or different materials and may be made of the same or different structures. One preferred polymeric material for such a polymeric backing structure is a polyolefin, with polypropylene being particularly preferred for many applications. The water filtration article may comprise a filter element (e.g., filter cartridge) comprising the filter membrane. By filter element, it is meant a structural assembly including the filtration membrane, which assembly is configured to be received within a filtration apparatus. The filter element may have an upstream side and a downstream side with the filtration membrane disposed between the upstream side and the downstream side. The filtration membrane may be in the form of tubes, fibers, pleated cartridges or flat disks, which form a part of a filter element.

The water filtration article may comprise a filter housing with an internal volume, a fluid inlet port for introducing a feed fluid into the internal volume and a fluid outlet port for removing filtrate fluid from the internal volume, and with the filtration membrane disposed in a flow path between the fluid inlet and the fluid outlet. The filtration membrane may be a part of a filter element disposed within the internal volume of such a filter housing.

The water filtration article may or may not be in an operational state. The water filtration article may be in an operational state comprising aqueous liquid flowing through the filtration membrane during a filtration operation. A differential pressure across the filtration membrane may be at least 6.9 kPa, at least 14 kPa or at least 21 kPa. Such a differential pressure may often be not larger than 100 kPa or not larger than 70 kPa. The water filtration article may be in an operative state comprising a flow of filtrate from the filtration membrane at a pressure-normalized flux according to any of the pressure-normalized flux features described previously. The water purification article may be disposed within the internal volume of a filter housing, such as previously discussed, with aqueous feed flowing into the internal volume through a fluid inlet port and aqueous liquid filtrate passing through the filtration membrane and flowing from the internal volume of the filter housing through an outlet port.

In a second aspect, a method for water filtration is provided, using a water filtration article according to the first aspect. The method includes directing a flow of an aqueous liquid feed to such a water filtration article, contacting at least a portion of the aqueous liquid feed with the filtration membrane of the water filtration article and collecting as purified filtrate a portion of the aqueous liquid feed passing through the filtration membrane.

A number of refinements and additional features may also be implemented with the method of the second aspect, which refinements and additional features may be used individually or in any combination, including with any combination of refinements and additional features described with respect to the water filtration article of the first aspect. Accordingly, the various refinements and additional features of the first aspect and that follow may or may not be used in any particular implementation of the method of the second aspect.

The contacting may comprise maintaining a pressure differential across the filtration membrane according to any of the differential pressures described above with the first aspect. The collecting may comprise flowing the filtrate through the filtration membrane at a pressure normalized flux which may be as discussed above with respect to the first aspect. In one preferred implementation of the method of the second aspect, the water filtration article includes the filtration membrane disposed in the internal volume of a filter housing, for example as discussed above with respect to the first aspect, and comprises directing flow of an aqueous liquid feed to the filter housing, introducing at least a portion of the aqueous feed through an inlet port into the internal volume to contact the filtration membrane, passing a portion of the aqueous liquid feed through the filtration membrane as filtrate, and removing at least a portion of the filtrate from the internal volume through an outlet port.

In a third aspect, a method for making a water filtration article is provided, which may be a water filtration article according to the first aspect. The method includes disposing uncrosslinked EVOH copolymer on at least a portion of a PTFE filtration layer of a porous PTFE structure, the PTFE filtration layer having a thickness of no larger than 10 microns. The method is performed substantially in the absence of cross-linking the uncrosslinked EVOH copolymer.

A number of refinements and additional features may also be implemented with the method of the third aspect, which refinements and additional features may be used individually or in any combination, including with any combination of refinements and features described with respect to the first aspect. Accordingly, the various refinements and additional features of the first aspect and that follow may or may not be used in any particular implementation of the method of the third aspect.

In some preferred implementations, the method may be substantially in the absence of chemically reacting the uncrosslinked EVOH copolymer in any manner, and not just through a cross-linking reaction. For example, the method may be substantially in the absence of reactions other than cross-linking reactions, such as to further functionalize or stabilize (other than through cross-linking) the uncrosslinked EVOH copolymer. The uncrosslinked EVOH copolymer may be or have features as described with the first aspect. Some examples of commercially available uncrosslinked EVOH copolymer include products under the Soarnol® name (Nippon Gohsei) and EVAL® name (Kuraray), such as EVAL® EP-F.

Disposing uncrosslinked EVOH copolymer may include depositing uncrosslinked EVOH copolymer onto all or portions of surfaces of the porous PTFE structure from a solution comprising the uncrosslinked EVOH copolymer dissolved in a solvent. The porous PTFE structure, or a portion thereof, may be contacted with such a solution, and in some preferred implementations such contact includes substantially saturating the porous PTFE filtration layer, and preferably the entire PTFE structure, with the solution. The solvent may then be removed from the solution to cause uncrosslinked EVOH copolymer to come out of solution and deposit on some or all surfaces of the porous PTFE structure. The solvent may be removed chemically (e.g., extraction into a liquid in which the uncrosslinked EVOH copolymer is not soluble) or by vaporization of the solvent. Such vaporization of the solvent may be aided by heating, preferably not at a temperature that will degrade the uncrosslinked EVOH copolymer. The solvent may be any solvent from which the uncrosslinked EVOH may be deposited on surfaces of the porous PTFE structure and which may be removed to leave a surface coating of the uncrosslinked EVOH copolymer. The solvent may be a solvent system including a mixture of solvent components (e.g., water and or alcohol). The uncrosslinked EVOH copolymer may be at any convenient concentration in the solution for processing. The concentration of the uncrosslinked EVOH copolymer in the solution may, for example, be conveniently in a range of from 25 mole percent to 44 mole percent.

During the disposing, the PTFE filtration layer, and preferably the entire porous PTFE structure, may be loaded with at least 0.1 weight percent, at least 0.5 weight percent, at least 1 weight percent, or at least 2 weight percent of the uncrosslinked ethylene-vinyl alcohol copolymer. The disposing may typically comprise loading the porous PTFE structure, or the PTFE filtration layer portion of the porous PTFE structure, with no more than 30 weight percent, no more than 20 weight percent, no more than 10 weight percent, no more than 5 weight percent or no more than 3 weight percent of the uncrosslinked EVOH copolymer.

The porous PTFE structure may be a single layer PTFE structure (i.e., only the PTFE filtration layer) or may be a multi-layer PTFE structure. The porous PTFE structure may be as described with the first aspect. The PTFE filter layer may have a property or properties described above for the filtration layer of the filtration membrane of the water filtration article, but without the hydrophilic coating. As will be appreciated, the PTFE filtration layer of the porous PTFE structure may become the filtration layer, and the porous PTFE structure may become the filtration membrane, with the hydrophilic coating following the disposing according to the third aspect. The porous PTFE structure may have any property or properties described above for the filtration membrane, but without the hydrophilic coating, even though there may be some differences in structural and dimensional properties (e.g., pore size, thickness) between the porous PTFF structure without the coating and resulting filtration membrane including the coating on the PTFE structure.

The PTFE structure may comprise at least one or more than one support layer adjacent the PTFE filtration layer. Such porous PTFE support layers may have an average pore size larger than an average pore size of the PTFE filtration layer and may have a thickness larger than the thickness of the PTFE filtration layer. The PTFE filtration layer and any such support layer may have structural and dimensional properties (e.g., thickness, pore size) as described above for the filtration layer and the support layers of the filtration membrane.

The method may include incorporating a filtration membrane including hydrophilic coating with uncrosslinked EVOH copolymer in a more complex structure, such as any of the more complex structures described above with the first aspect. For example, the porous PTFE structure, following the disposing step, may be laminated with a backing layer or more than one backing layers. As another example, the porous PTFE layer, following the disposing step, may be incorporated into a filter element (e.g., a cartridge). As another example, the porous PTFE structure, following the disposing step, may be disposed in an internal volume of a filter housing.

Numerous additional modalities, features and advantages of the present invention may become apparent to those skilled in the art upon consideration of the embodiment descriptions provided below.

### BRIEF DESCRIPTION OF THE DRAWINGS

FIG. 1 illustrates one embodiment of a water filtration article.

FIG. 2 shows a scanning electron microscope (SEM) image of a multi-layered expanded polytetrafluoroethylene membrane.

FIG. 3 illustrates another embodiment of a water filtration article.

FIG. 4 illustrates another embodiment of a water filtration article.

FIG. 5 illustrates another embodiment of a water filtration article.

FIG. 6 is a generalized process block diagram form one embodiment of a method for making a water filtration article.

FIG. 7 illustrates a process alternative for applying a solution of uncrosslinked ethylene-vinyl alcohol copolymer to a porous polytetrafluoroethylene structure.

FIG. 8 illustrates another process alternative for applying a solution of uncrosslinked ethylene-vinyl alcohol copolymer to a porous polytetrafluoroethylene structure.

FIG. 9 illustrates a process alternative for removing solvent from a solution of uncrosslinked ethylene-vinyl alcohol copolymer after application of the solution to a porous polytetrafluoroethylene structure.

### DETAILED DESCRIPTION OF ILLUSTRATED EMBODIMENTS

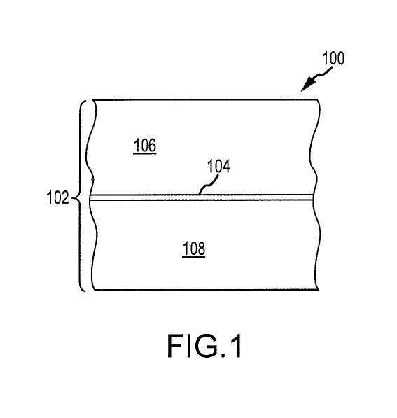

FIG. 1 illustrates an embodiment of a water filtration article. As shown in FIG. 1, a water filtration article 100 is in the form of a multi-layer filtration membrane 102 including a stack of three membrane layers. The filtration membrane 102 includes a filtration layer 104, and a first porous support layer 106 and a second porous support layer 108 disposed on opposing sides of the filtration layer 104. The filtration layer 104 is a thin layer that is the active filtration layer with a smaller pore size that determines the particle-size separation performance of the water filtration article 100. The porous support layers 106 and 108 have much larger thicknesses, much larger-size pores and much higher permeability than the filtration layer 104. For example, the average pore size of the support layers 106 and 108 may be an order of magnitude or more larger than the average pore size of the filtration layer 104. As another example, the thickness of each of the porous support layers 106 and 108 may be an order of magnitude or more larger than the thickness of the filtration layer. The filtration layer 104 and porous support layers 106 and 108 are all composed of porous, expanded polytetrafluoroethylene that has been coated with a hydrophilic coating comprising uncrosslinked ethylene-vinyl alcohol copolymer. The porous ePTFE of all of the filtration layer 104 and support layers 106 and 108, together, make up a porous PTFE structure of the filtration membrane 102.

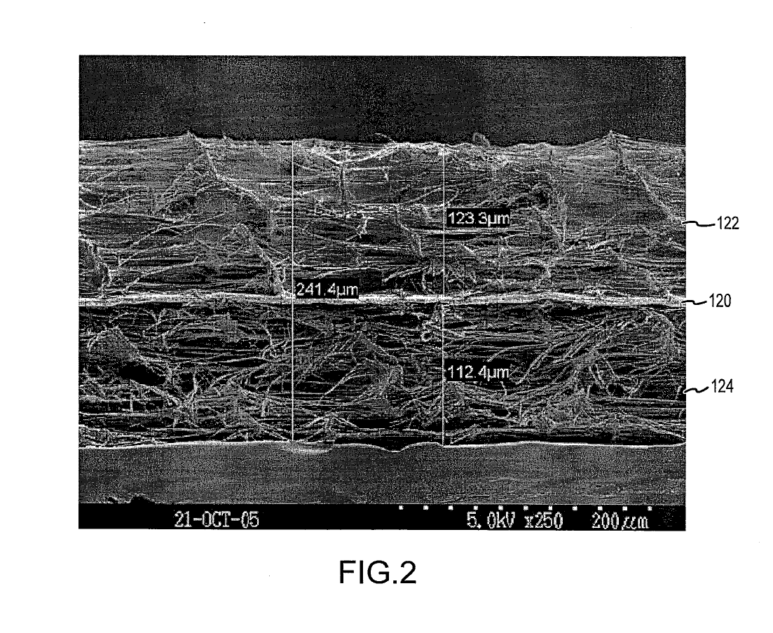

Reference is now made to FIG. 2, which shows a SEM image across the thickness of an ePTFE membrane including a stack of three distinct ePTFE layers. Such a multi-layer ePTFE membrane provides an example of a porous multi-layer PTFE structure that may be coated with a hydrophilic coating to prepare a water filtration article according to the invention. As seen in FIG. 2, the ePTFE membrane has an ePTFE filtration layer 120, and a first ePTFE porous support layer 122 and a second ePTFE porous support layer 124 disposed on opposing sides of the filtration layer 120. The filtration layer 120 in the example shown in FIG. 2 has a thickness of about 5 microns, while the ePTFE membrane has a total width of about 240 microns. As is seen in FIG. 2, the filtration layer 120 has a much more dense, closed structure, with much smaller pores, than the porous support layers 122 and 124.

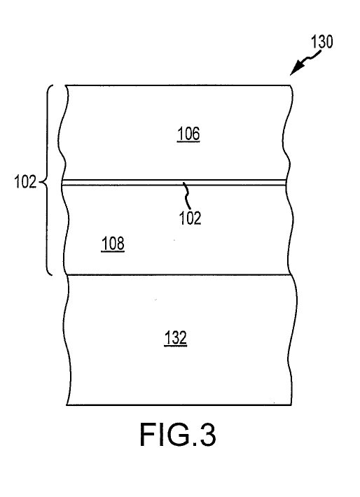

Reference is now made to FIG. 3, which illustrates another embodiment of a water filtration article. As shown in FIG. 3, a water filtration article 130 includes the filtration membrane 102 (of FIG. 1) laminated with a polymeric backing layer 132, to provide further structural support and protection to the filtration membrane 102. The polymeric backing layer may, for example, be a woven, non-woven, knit, net or other porous structure, and may be made, for example, from a polyolefin (e.g., polypropylene).

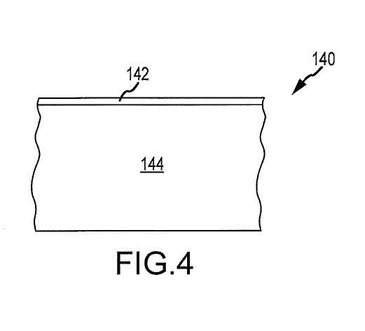

Reference is now made to FIG. 4, which illustrates another embodiment of a water filtration article. As shown in FIG. 4, a water filtration article 140 includes a filtration membrane 142 supported on and laminated to a porous backing layer 144, which may be a similar structure to the backing layer 132 described with respect to FIG. 3. The filtration membrane 142 in the embodiment shown in FIG. 4 is made up of only a single filtration layer. The filtration membrane 142 may, for example, be a filtration layer of ePTFE coated with a hydrophilic coating comprising uncrosslinked EVOH copolymer. Such a ePTFE layer may, for example, be similar to the filtration layer 120 shown in the multi-layer structure of FIG. 4, but supported directly on the backing layer 144 rather than sandwiched between supporting porous layers of ePTFE.

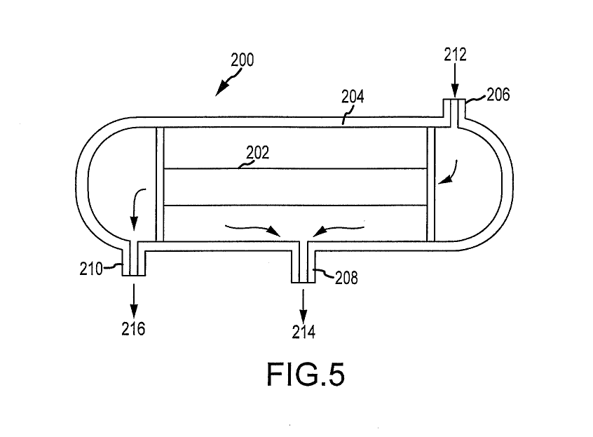

Reference is now made to FIG. 5, which illustrates another embodiment of a water filtration article. As shown in FIG. 5, a water filtration article 200 includes a filter element 202 in the form of a tubular cartridge disposed within an internal volume of a filter housing 204. The filter element 202 includes a filtration membrane with a porous PTFE structure and a hydrophilic coating comprising uncrosslinked EVOH copolymer. The filter housing 204 has a fluid inlet port 206, a first fluid outlet port 208 and a second fluid outlet port 210. The filter element 202 has an upstream side on the inside of the tube and a downstream side on the exterior of the tube. During operation of the water filtration article 200 for filtration of water, an aqueous feed fluid 212 is introduced into the internal volume of the filter housing 204 through the fluid inlet port 206 and clean filtrate fluid 214 is removed from the internal volume of the filter housing 204 through the first fluid outlet port 208. Retentate 216 is removed from the internal volume of the filter housing 204 through the second fluid outlet port 210. In the embodiment shown in FIG. 5, the water filtration article 200 is configured for cross-flow filtration with the aqueous fluid feed 212 flowing into the interior of the filter element 202 to contact the upstream side of the filter element. Some of the aqueous fluid feed 212 passes through the membrane filter of the filtration element 202 to form the permeate 214. The portion of the aqueous feed 212 that does not pass through the filtration membrane is removed as the retentate 216. Arrows shown within the internal volume of the filter housing 204 show generally, the flow of fluid during operation. As an alternative implementation, a water filtration article similar to that shown in FIG. 5 could be configured for operation for dead-end filtration rather than cross-flow filtration, in which case the second outlet fluid port 210 would not be needed, and all fluid exiting the filter housing would be in the filtrate.

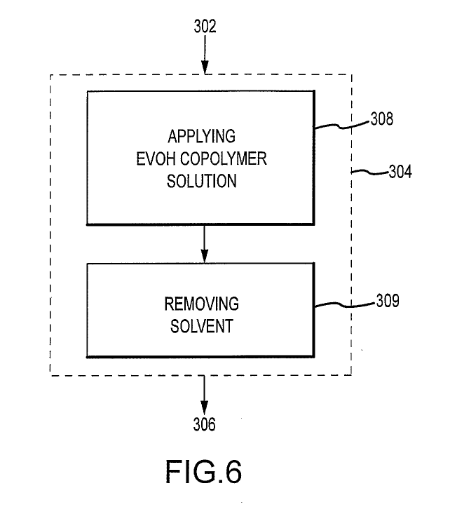

Referring now to FIG. 6, a process block diagram is shown for one embodiment of a method for making a water filtration article. As shown in FIG. 6, a porous PTFE filtration membrane precursor 302 is processed through a disposing step 304 to prepare a water filtration article in the form of a filtration membrane 306. The filtration membrane precursor 302 may be a porous PTFE structure including at least one layer that will function as the filtration layer in the filtration membrane 306. The filtration membrane precursor 302 may be a single layer porous PTFE structure, wherein the entire structure will be a filtration layer in the filtration membrane 306, or the filtration membrane precursor 302 may be a multi-layer structure, for example as shown in FIG. 2.

With continued reference to FIG. 6, the disposing step 304 includes a step 308 of applying EVOH copolymer solution to the filtration membrane precursor 302. The EVOH copolymer solution may include an uncrosslinked EVOH copolymer dissolved within an appropriate solvent. During the applying step 308, the EVOH copolymer solution is applied to the porous PTFE structure of the filtration membrane precursor 302 to obtain intimate contact between the solution and PTFE surfaces of the PTFE filtration membrane precursor 302, and preferably intimate contact with substantially all surfaces of filtration membrane precursor 302. At the conclusion of the applying step 308, the filtration membrane precursor 302 preferably is completely wetted by the EVOH copolymer solution.

With continued reference to FIG. 6, following the applying step 308, the filtration membrane precursor 302 wetted with EVOH copolymer solution is subjected to a step 309 of removing solvent, to promote uncrosslinked EVOH copolymer to come out of solution and deposit on PTFE surfaces of the filtration membrane precursor 302. At the conclusion of the removing step 309, preferably substantially all of the solvent has been removed from the porous structure of the filtration membrane precursor 302, leaving a coating of the uncrosslinked EVOH copolymer on PTFE surfaces throughout the porous PTFE structure, and thereby preparing the filtration membrane 306.

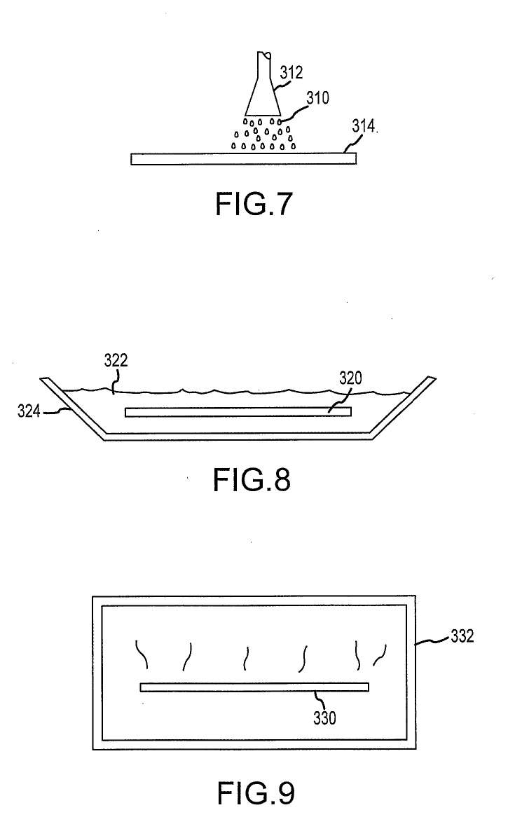

FIG. 7 illustrates one example processing alternative that may be employed during the applying step 308 of the processing of FIG. 6. As shown in FIG. 7, a spray 310 of uncrosslinked EVOH copolymer solution emitted from a spray device 312 is applied to a porous PTFE membrane structure 314.

FIG. 8 illustrates another example processing alternative for use during the applying step 308 of the processing shown in FIG. 6. As shown in FIG. 8, a porous PTFE membrane structure 320 is submerged in a bath 322 of uncrosslinked EVOH copolymer solution within a container 324.

FIG. 9 illustrates an example processing alternative for use during the removing step 309 of the processing shown in FIG. 6. As shown in FIG. 9, a porous PTFE membrane structure 330, wetted with uncrosslinked EVOH copolymer solution, is disposed in a heated oven 332 to cause evaporation of solvent to leave a coating of uncrosslinked EVOH copolymer on PTFE surfaces of the porous PTFE membrane structure 330.

### EXAMPLES

### Example 1

### Uncrosslinked EVOH Copolymer Coating

0.15 g of commercially available EVOH copolymer (Soarnol® D2908) was added to 30 g isopropyl alcohol, 15 g 2-butanol and 54.85 g de-ionized water and the mixture was heated to around 80°0 C. for 2-4 hours with stirring until all polymer pellets were dissolved and a clear solution was formed. The solution was cooled to room temperature.

An expanded PTFE membrane (3-layer support/filter layer/support construction, bubble point of 55 psi, total thickness of about 102 micron) was anchored on a 6 inch hoop. The above coating solution (0.15 wt % EVOH in solution) was applied through a pipette to both sides of the membrane. The ePTFE membrane was saturated with the EVOH copolymer solution and the EVOH copolymer was adsorbed onto the PTFE surfaces. The resulting wet membrane was then dried in an oven at 65° C. to remove the solvent. The dried membrane had 2.1 wt % uncrosslinked EVOH copolymer as measured by thermo gravimetric analysis (TGA) using weight loss between 125° C. and 375° C. in air.

The water wet-out ability of the resulting filtration membrane was measured using the water flow rate test method (summarized below). The filtration membrane's water flux rate (normalized to pressure) was measured to be 7 ml/min/cm²/psi (1 ml/min/cm²/kPa). The organic extractables were measured and results reported in Table I below. As shown, the filtration membrane not only had a very good ability to wet-out water, but also extremely low residue levels, as measured by organic extractables.

A sample of the resulting membrane (size 10×10 cm) was soaked in hot water (about 80 degrees Celsius) for 30 days. After 30 days, the membrane was dried. The coating weight using TGA analysis on this dried sample was measured to be 2.1 wt % EVOH, indicative of no change in coating weight prior to soaking in hot water for 30 days. This is illustrative of long-term stability of the coating. The dried membrane sample was anchored in a 10.16 cm diameter hoop. A single droplet of water was dropped on the membrane surface from a height of 5 cm directly above the sample on to the sample. It took less than 10 seconds for the droplet to penetrate the pores of the sample, indicative of instantaneous water wettability even after this extended period.

### Comparative Example 1

### Cross-Linked Polyvinyl Alcohol Coating

The expanded PTFE membrane from Example 1 was coated using a solution of 0.5% polyvinyl alcohol in a 30/15/55 mixture of isopropyl alcohol/2-butanol/water and then cross-linked using 2% glutaraldehyde in the presence of 1% hydrochloric acid. This was followed by a tap water rinse for 1 minute. The sample was then dried at 150° C. The membrane's water flux rate (normalized to pressure) was measured to be 5.4 ml/min/cm²/psi (0.78 ml/min/cm²/kPa). The organic extractables were measured and results reported in Table 1.

### Comparative Example 2

### Cross-Linked EVOH Copolymer Coating

The expanded PTFE membrane from Example 1 was coated using a solution of 0.15 wt % EVOH copolymer (Soarnol® D2908), 0.25 wt % HCl and 0.1 wt % glutaraldehyde in a 30/15/55 solvent mixture of isopropyl alcohol/2-butanol/water. The resulting wet membrane was then dried in an oven at 65° C. to remove the solvent. The organic extractables were measured and results are reported in Table 1.

### Comparative Example 3

### Cross-Linked EVOH Copolymer Coating

The EVOH coated expanded PTFE membrane from Example 1 was further subject to cross-linking using 0.1% glutaraldehyde in the presence of 0.25% hydrochloric acid in water. The sample was dried at 65° C. to remove water. The organic extractables were measured and results are reported in Table 1.

### Water Flow Rate Test Method

This method was used to determine the ability of filtration membranes to wet-out water without pre-wetting with aids such as surfactant or a solvent. A dry membrane was draped across the tester (Sterifil Holder 47 mm Catalog Number: XX11J4750, Millipore). The test holder was filled with de-ionized water (room temperature). A 10-inch Hg (4.9 psi, 33.8 kPa) vacuum was applied across the membrane; the time for 400 ml of de-ionized water to flow through the membrane was measured. The water flow, as measured by water flux, of the membrane was reported in units of ml/min/cm². A sample is considered to have good water wet-out ability if the water flux through the sample is greater than 0.01 ml/min/cm².

### Test for Organic Extractables

The following test method was used to measure organic extractables from a membrane using acetonitrile as the solvent. A High Performance Liquid Chromatography (HPLC) system was used for the analysis. The system comprised a Waters 2695 pump, an autosampler module and a Waters 2996 UV/Vis photodiode array detector. The detector was set to monitor at wavelengths of 214 nm and 254 nm.

For some samples, a Supelco Ascentis Express C18 column was used for the separation. The column ID and length were 3.0 mm and 50 mm respectively. The diameter of the column packing was 2.7 microns. A linear gradient from 90% (90% H₂O/10% methanol):10% acetonitrile to 100% acetonitrile over 10 minutes was employed and the mobile phase was held at 100% acetonitrile for an additional 4 minutes. The mobile phase flow rate was 0.3 mL/min.

Membrane samples (26.5 cm² per side) were soaked in acetonitrile for 30 minutes at room temperature. The extract solution was then transferred into the HPLC autosampler, an injection volume of 20 μL was used for the analysis. A blank sample consisting of the acetonitrile reagent was also analyzed.

The chromatograms obtained were analyzed for the peaks at wavelengths of 214 nm and 254 nm. Specifically, peaks at these wavelengths not seen in the samples of the acetonitrile reagent blanks in Table 1 are noted. The results were reported in terms of peak height at the above wavelengths in units of mV. As seen in Table 1, all example filtration membranes containing a cross-linked polymer coating had significantly higher levels of measured extractable organic contaminants than the example filtration membrane with a coating of uncrosslinked EVOH copolymer.

TABLE 1

| | Maximum Peak | Maximum Peak |
|---|---|---|
| | height at 214 nm (mV) | height at 254 nm (mV) |
| Example 1 | <0.1 | <0.1 |
| Comparative | 7.8 | 7.4 |
| Example 1 | | |
| Comparative | <0.1 | 0.7 |
| Example 2 | | |
| Comparative | 0.6 | 1.7 |
| Example 3 | | |

### Bubble Point Measurement

Bubble point and mean flow pore size are determinable according to the general teachings of ASTM F31 6-03. As an example, a measurement may be made using a Capillary Flow Porometer (e.g., Model CFP 1500 AEXL from Porous Materials Inc., Ithaca, N.Y.). A sample membrane may be placed into the sample chamber and wetted (e.g., with SilWick Silicone Fluid, available from Porous Materials Inc., having a surface tension of 19.1 dynes/cm). A bottom clamp of the sample chamber may have a 2.54 cm diameter, 3.175 mm thick porous metal disc insert (e.g., Mott Metallurgical, Farmington, Conn., 40 micron porous metal disk) and the top clamp of the sample chamber may have a 3.175 mm diameter hole. Capwin software (e.g., version 6.62.1) may be used, with the following parameters were set, for example, as specified in Table 2 below. Multiple measurements (e.g., two) may be made and averaged for reported bubble point and/or flow pore size.

TABLE 2

| Parameter | Set Point |
|---|---|
| maxflow (cc/min) | 200000 |
| bublflow (cc/min) | 100 |
| F/PT (old bubltime) | 40 |
| minbppres (psi) | 0 |
| zerotime (sec) | 1 |
| v2incr (cts) | 10 |
| preginc (cts) | 1 |
| pulse delay (sec) | 2 |
| maxpre (psi) | 500 |
| pulse width (sec) | 0.2 |
| mineqtime (sec) | 30 |
| presslew (cts) | 10 |
| flowslew (cts) | 50 |
| eqiter | 3 |
| aveiter | 20 |
| maxpdif (psi) | 0.1 |
| maxfdif (cc/m) | 50 |
| sartp (psi) | 1 |
| sartf (cc/min) | 500 |

The foregoing discussion of the invention and different aspects thereof has been presented for purposes of illustration and description. The foregoing is not intended to limit the invention to only the form or forms specifically disclosed herein. Consequently, variations and modifications commensurate with the above teachings, and the skill or knowledge of the relevant art, are within the scope of the present invention. The embodiments described hereinabove are further intended to explain best modes known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art. Although the description of the invention has included description of one or more possible implementations and certain variations and modifications, other variations and modifications are within the scope of the invention, e.g., as may be within the skill and knowledge of those in the art after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly disclaim or dedicate any patentable subject matter. Furthermore, any feature described or claimed with respect to any disclosed implementation may be combined in any combination with one or more of any other features of any other implementation or implementations, to the extent that the features are not necessarily technically compatible, and all such combinations are within the scope of the present invention.

The terms “comprising”, “containing”, “including” and “having”, and grammatical variations of those terms, are intended to be inclusive and nonlimiting in that the use of such terms indicates the presence of some condition or feature, but not to the exclusion of the presence also of any other condition or feature. The use of the terms “comprising”, “containing”, “including” and “having”, and grammatical variations of those terms in referring to the presence of one or more components, subcomponents or materials, also include and is intended to disclose the more specific embodiments in which the term “comprising”, “containing”, “including” or “having” (or the variation of such term) as the case may be, is replaced by any of the narrower terms “consisting essentially of or “consisting of or “consisting of only” (or the appropriate grammatical variation of such narrower terms). For example, a statement that some thing “comprises” a stated element or elements is also intended to include and disclose the more specific narrower embodiments of the thing “consisting essentially of the stated element or elements, and the thing “consisting of the stated element or elements. Examples of various features have been provided for purposes of illustration, and the terms “example”, “for example” and the like indicate illustrative examples that are not limiting and are not to be construed or interpreted as limiting a feature or features to any particular example. The term “at least” followed by a number (e.g., “at least one”) means that number or more than that number. The term at “at least a portion” means all or a portion that is less than all. The term “at least a part” means all or a part that is less than all.

What is claimed is:

1. A water filtration article, comprising a filtration membrane comprising a porous polytetrafluoroethylene (PTFE) structure and a hydrophilic coating over at least a portion of the porous PTFE structure, the filtration membrane comprising:
a filtration layer having a thickness of no larger than 10 microns, the filtration layer comprising:
porous PTFE filtration media; and
the hydrophilic coating on the PTFE filtration media, the hydrophilic coating comprising uncrosslinked ethylene-vinyl alcohol copolymer.

2. A water filtration article according to claim 1, wherein the filtration layer has an average pore size of no larger than 0.2 micron.

3. A water filtration article according to claim 2, wherein the filtration layer has an average pore size of at least 0.005 micron.

4. A water filtration article according to claim 1, wherein the coating consists essentially of uncrosslinked ethylene-vinyl alcohol copolymer.

5. A water filtration article according to claim 1, wherein the filtration membrane consists essentially of PTFE and uncrosslinked ethylene-vinyl alcohol copolymer.

6. A water filtration article according to claim 5, wherein the filtration membrane comprises from 99.9 to 70 weight percent PTFE and from 0.1 to 30 weight percent uncrosslinked ethylene-vinyl alcohol copolymer.

7. A water filtration article according to claim 6, wherein PTFE and ethylene-vinyl alcohol copolymer together comprise at least 90 weight percent of the filtration membrane.

8. A water filtration article according to claim 1, wherein:
the filtration membrane comprises a porous support layer adjacent a side of the filtration layer;
the porous support layer has a thickness larger than the thickness of the filtration layer;
the porous support layer has an average pore size larger than an average pore size of the filtration layer; and
the support layer comprises a portion of the porous PTFE structure comprising the hydrophilic coating.

9. A water filtration article according to claim 8, wherein:
the porous support layer is a first porous support layer and the side of the filtration layer is a first side of the filtration layer and the portion of the porous PTFE structure is a first portion of the porous PTFE structure;
the filtration membrane comprises a second porous support layer adjacent a second side of the filtration layer opposite the first side;
the second support layer has a thickness larger than the thickness of the filtration layer;
the second support layer has an average pore size larger than the average pore size of the filtration layer; and
the second support layer comprises a second portion of the porous PTFE structure comprising the hydrophilic coating.

10. A water filtration article according to claim 9, wherein each of the filtration layer, the first porous support layer and the second porous support layer consists essentially of PTFE and uncrosslinked ethylene-vinyl alcohol copolymer.

11. A water filtration article according to claim 1, wherein the filtration membrane has a thickness in a range of from 0.5 micron to 5 microns.

12. A water filtration article according to claim 1, wherein the filtration membrane is laminated with a porous polymeric backing structure.

13. A water filtration article according to claim 12, wherein the polymeric backing structure comprises polyolefin.

14. A water filtration article according to claim 12, wherein the polymeric backing structure comprises polypropylene.

15. A water filtration article according to claim 1, wherein the filtration membrane has a bubble point in a range of from 200 to 1400 kPa.

16. A water filtration article according to claim 1, wherein the filtration membrane has a pressure-normalized water flux of at least 0.01 ml/min/cm²/kPa.

17. A water filtration article according to claim 1, comprising a filter element with an upstream side and a downstream side and comprising the filtration membrane disposed between the upstream side and the downstream side.

18. A water filtration article according to claim 17, comprising:
a filter housing comprising an internal volume, a fluid inlet port for introducing a feed fluid into the internal volume and a fluid outlet port for removing filtrate fluid from the internal volume; and
the filter element disposed within the internal volume with the filtration membrane disposed in a flow path between the fluid inlet and the fluid outlet.

19. A water filtration article according to claim 18, comprising;
aqueous liquid feed flowing into the internal volume through the fluid inlet port;
aqueous liquid filtrate passing through the filtration membrane and flowing from the internal volume through the outlet port; and
a differential pressure of at least 6.9 kPa across the filtration membrane.

20. A water filtration article according to claim 19, comprising a flow of the filtrate through the filtration membrane at a pressure-normalized flux of at least 0.01 ml/min/cm²/kPa.

21. A method for filtration of water, the method comprising:
directing flow of an aqueous liquid feed to the water filtration article of claim 1;
contacting at least a portion of the aqueous liquid feed with the filtration membrane; and
collecting as a purified filtrate a portion of the aqueous liquid feed passing through the filtration membrane.

22. A method according to claim 21, comprising during the contacting, maintaining a pressure differential across the filtration membrane of at least 6.9 kPa.

23. A method according to claim 22, wherein the collecting comprises flowing the filtrate through the filtration membrane at a pressure normalized flux of at least 0.01 ml/min/cm²/kPa.

24. A method for filtration of water, the method comprising:
directing flow of an aqueous liquid feed to the water filtration article of claim 18;
introducing at least a portion of the aqueous liquid feed through the inlet port into the internal volume to contact the filtration membrane;
passing a portion of the aqueous liquid feed through the filtration membrane as a filtrate; and
removing at least a portion of the filtrate from the internal volume through the outlet port.

25. A method for making a water filtration article, the method comprising:
disposing uncrosslinked ethylene-vinyl alcohol copolymer on at least a portion of a polytetrafluoroethylene (PTFE) filtration layer of a porous PTFE structure, the PTFE filtration layer having a thickness of no larger than 10 microns; and
wherein the method is substantially in the absence of cross-linking the ethylene-vinyl alcohol copolymer.

26. A method according to claim 25, wherein the method is substantially in the absence of chemically reacting the ethylene-vinyl alcohol copolymer.

27. A method according to claim 25, wherein the disposing comprises depositing the uncrosslinked ethylene-vinyl alcohol copolymer onto surfaces of the porous PTFE filtration layer from a solution comprising the uncrosslinked ethylene-vinyl alcohol copolymer dissolved in a solvent.

28. A method according to claim 27, wherein the depositing comprises removing the solvent from the PTFE filtration layer by vaporization.

29. A method according to claim 25, wherein the disposing comprises loading the porous PTFE filtration layer with from 0.1 to 5 weight percent of the uncrosslinked ethylene-vinyl alcohol copolymer.

30. A method according to claim 25, comprising, after the disposing, supporting the porous PTFE filtration layer on a backing layer.

31. A method according to claim 25, wherein:
the porous PTFE filtration layer is part of a PTFE structure comprising at least one porous PTFE support layer adjacent to the porous PTFE filtration layer;
the PTFE support layer has a thickness larger than the thickness of the porous PTFE filtration layer;
the porous PTFE support layer has an average pore size larger than an average pore size of the filtration layer; and
during the disposing, uncrosslinked ethylene-vinyl alcohol copolymer is disposed on the porous PTFE support layer.

32. A method according to claim 31, wherein:
the porous PTFE support layer is a first porous PTFE support layer and the porous PTFE structure comprises a second porous PTFE support layer;
the first porous PTFE support layer adjoins a first side of the PTFE filtration layer and the second porous PTFE support layer adjoins a second side of the PTFE filtration layer that is opposite the first side;
the second porous PTFE support layer has a thickness larger than the thickness of the porous PTFE filtration later;
the second porous PTFE support layer has an average pore size larger than an average pore size of the filtration layer; and
during the disposing, uncrosslinked ethylene-vinyl alcohol copolymer is disposed on the second porous PTFE support layer.

33. A method according to claim 25, wherein the porous PTFE filtration layer has an average pore size of at least 0.005 micron.
